(19) United States
(12) Patent Application Publication
(10) Pub. No.: US 2015/0214991 A1
(43) Pub. Date: Jul. 30, 2015

(54) Housing for Portable Electronic Device

(71) Applicant: Dog & Bone Holdings Pty Ltd, Willawong (AU)

(72) Inventors: Lee Brett Ranchod, Willawong (AU); Scot Farley, Gumdale (AU)

(21) Appl. No.: 14/419,009

(22) PCT Filed: Aug. 2, 2013
(86) PCT No.: PCT/AU2013/000856

§ 371 Date: Feb. 2, 2015

(30) Foreign Application Priority Data
Aug. 2, 2012 (AU) 2012903343

(51) Int. Cl. H04B 1/3888

(52) U.S. Cl. CPC H04B 1/3888; H04B 2001/3894

(57) ABSTRACT

A housing for a portable electronic device including a first housing member adapted for complementary engagement with a second housing member, a sleeve for encapsulation of the portable electronic device, and whereby a moisture resistant seal is provided on engagement of the first and second housing members about the sleeve and said portable electronic device.

### TECHNICAL FIELD

The present invention relates to a housing for a portable electronic device. In particular although not exclusively the present invention relates to a water resistant casing for portable electronic devices.

### BACKGROUND ART

Covers for most portable electronic devices can be divided into two broad categories hard casings and soft casings. Of the two forms of casing soft casings have been a popular choice normally these are constructed from leather, neoprene, silicone etc. Early forms of soft casings were typically designed to envelope the portable device in such cases the casing was provided with windows vinyl inserts to enable access to the device keys etc.

With the recent rise in popularity of touch screen devices has seen the design of soft covers change somewhat. Typically most soft covers for touch screen phones etc. are in form of a silicon glove which encases the body of the phone with a number of cut outs provided in the case to enable the user direct access to the screen and other function buttons. Additional cut outs may be provide to accommodate the operation of auxiliary devices such as front and rear cameras etc. An alternate form of soft casings which has proved popular are flip casings where the cover includes a sleeve or the like covering the rear face of the device and an upper member which is hinged to the sleeve and can be selectively engaged and disengaged against the front face of the device as needed.

While soft covers have proved popular they often do not provide adequate protection against impact or shock etc. With the current generation of smart phones the tendency for severe damage to the phone occurring due to the phone being dropped is relatively high. For example the current version of the iPhone (i.e. iPhone 4 and 4s) is that there is a high risk of the screen being cracked or shattered due to phone being dropped. Indeed the tendency for screen damage occurring with light impacts is relatively high. This risk of damage to the phone and its primary means of input has seen an increase in the popularity of hard cases which provided a greater degree of ruggedisation to that of soft covers.

In most instances hard covers are constructed form a suitable polymer and are designed to slide over or snap onto the rear face of device such that the portion of the cover extends around the sides of the device. While the use of these hard cases provides a greater degree of protection to the device against impact or shock they like the majority of soft covers leave the front face/screen of the device relatively unprotected.

Each of the above types of cover provide varying degrees of impact protection for the device without essentially altering the operation of the device they, however, do not protect the device against other environmental factors such as moister ingress or dust or other particulates which can cause screen damage. Presently there are a number of water proof/water resistant cases available for various portable electronic devices. Typically these cases place the device in a sealed-chamber with the device either mechanically or electrically coupled to controls mounted externally to the chamber. While these cases provide adequate protection for the device against moisture ingress and particulates they limit the operability of the device as the user interaction with the device is constrained to a select set of function keys (less than ideal for a device with a primary mode of input requiring contact in some form with the screen). In addition to limiting the inputs available to the device the cases themselves are often bulky/cumbersome construction to ensure a proper sealing of the chamber and provide the secondary controls for the device.

Clearly it would be advantageous to provide a protective cover for a portable electronic device which is relatively compact. It would also be advantageous to provide a protective case which enables a user to interact with the device normally while providing a suitable level of environmental protection for the device.

### SUMMARY OF INVENTION

Accordingly in one aspect of the present invention there is provided a housing for a portable electronic device the housing

a first housing member;

a second housing member; and

wherein the first housing member is adapted for complementary engagement with the second and whereby a moisture resistant seal is provided on engagement of the first and second housing members about the portable electronic device.

Suitably the first housing members may be provided with a membrane layer disposed on interior face to permit interaction with the portable electronic device. Preferably the sealing relation between the first and second housing members is via the use of an O-ring or grommet. In such cases the O-ring or grommet may be positioned within a channel disposed bailout the periphery of one of the shells with the opposing shell being provided with a flange for complementary with the channel such that when the shells are engaged the flange is forces against the O-ring or grommet to create a water tight seal.

In yet another aspect of the present invention there is provided housing for a portable electronic device the housing including:
a first housing member adapted for complementary engagement with a second housing member;

a sleeve for encapsulation of the portable electronic device; and

whereby a moisture resistant seal is provided on engagement of the first and second housing members about the sleeve and said portable electronic device.

Suitably the moisture resistant seal does not impact upon normal operation of the portable electronic device.

Preferably the first and second housing members are constructed form a suitably durable material such as any suitable polymer, metals, fibre composites or the like. Suitably the first and second housing members are formed from a polyvinyl material

The housing may include one or more cut out sections to accommodate various function buttons and auxiliary components of the device. Preferably the first and second housing members include one or more scalloped sections which on engagement of the housing members form one or more of the cut out sections. Suitably one or the housing members includes a cut out section for receipt of an insert.

Portions of more rigid material may be provided in the sleeve to correspond to components of the portable device. For example, I/O ports, a camera, microphone or speaker locations may be provided with a more rigid insert in the sleeve. Components which are less likely to be damaged such as function buttons may not require a more rigid insert. The more rigid inserts may be provided with additional resilient sealing portions.

The sleeve may partially or fully encapsulate the portable electronic device. The sleeve is preferably formed form any suitable clear flexible water resistant material. The sleeve may be formed from any suitable polymer such as a polyvinyl or polyurethane based polymers. Alternately the sleeve could be formed from a translucent or opaque material such as silicone or the like.

In such cases the sleeve may include a cut out to accommodate the screen of the portable electronic device which would have a suitable protective film applied prior to insertion of the device within the sleeve. In some instances where the screen protective material and the remainder of the membrane are compatible the screen protector could be welded or adhered to the sleeve prior to insertion of the device. Suitably where the portable electronic device utilises a capacitive screen the portion of the sleeve covering the screen is of sufficient transmissibility to enable registration of a screen tap or other such gesture.

In a most preferred form, the sleeve in combination with the housing may provide a sufficient seal against the electronic device or a portion thereof about a screen of the device, that the protective film is not required and the screen of the device is completely unobstructed. In this case, a seal is formed by the sleeve and housing in combination, about the screen of the device or a portion thereof.

In the case where the sleeve partially encapsulates the portable electronic device the insert may be utilised in conjunction with the sleeve to provide the moisture resistant. Suitably the insert may be constructed from a moisture resistant material. Preferably the insert is provided within the housing member which encapsulates the rear of the portable electronic device. Suitably the insert finishes substantially flush with the interior and exterior faces of the housing member in which it is installed. Preferably the portion of the insert which finishes substantially flush with the exterior face of the housing member includes one or more surface effects.

In another embodiment, the insert may stand proud of the exterior face of the housing member in which it is installed. In this embodiment, the insert may be of a material of a relatively high co-efficient of friction to limit or prevent slippage when the housing is placed on the insert on a surface. The insert may be integrally formed with the sleeve or separate therefrom.

Preferably the housing may be provided with one or more plug and/or doors for capping the various ports of the portable electronic device. The plugs or doors may be provided with additional sealing mechanism as these portions are likely to be points of weakness for the ingress of liquid or dust or similar and therefore warrant additional protection.

The reference to any prior art in this specification is not, and should not be taken as an acknowledgement or any form of suggestion that the prior art forms part of the common general knowledge.

### BRIEF DESCRIPTION OF DRAWINGS

In order that this invention may be more readily understood and put into practical effect, reference will now be made to the accompanying drawings, which illustrate preferred embodiments of the invention, and wherein:

FIGS. 1A and 1B are perspective view of a case for a portable electronic device with the portable electronic device in situ according to one embodiment of the present invention;

FIGS. 2A to 2D are schematic diagrams depicting the case of FIGS. 1A and 1B in various stages of assembly;

FIG. 3 is a cross sectional view of the case of FIGS. 1A and 1B;

FIG. 4 is an enlarged sectional view of case of taken from section A of FIG. 3;

FIG. 5 is a further enlarged sectional case of FIGS. 1A and 1B.

FIG. 6 is an exploded isometric view from the top and front of a case according to a preferred embodiment of the present invention.

FIG. 7 is an exploded isometric view from the bottom and rear of the case illustrated in FIG. 6.

FIG. 8A is a schematic illustration of detail surrounding an access door provided in a case according to a preferred embodiment of the present invention.

FIG. 8B is an isometric view of a rigid insert provided in a sleeve of a case according to the embodiment illustrated in FIG. 8A.

FIG. 8C is an end elevation view of the insert illustrated in FIG. 8B.

FIG. 8D is an isometric view of a pad included in the embodiment illustrated in FIG. 8A.

FIG. 9A is a schematic illustration of detail surrounding an access door provided in a case according to an alternative preferred embodiment of the present invention.

FIG. 9B is an isometric view of a rigid insert provided in a sleeve of a case according to the embodiment illustrated in FIG. 9A.

FIG. 9C is an isometric view of the bung and tether illustrated in FIG. 9A.

FIG. 9D is an isometric view of a bung without tether which can be used in the embodiment illustrated in FIG. 9A instead of the bung and tether.

FIG. 10 is a detailed rendering of a further alternative access door configuration provided in a case according to an alternative preferred embodiment of the present invention.

### DESCRIPTION OF EMBODIMENTS

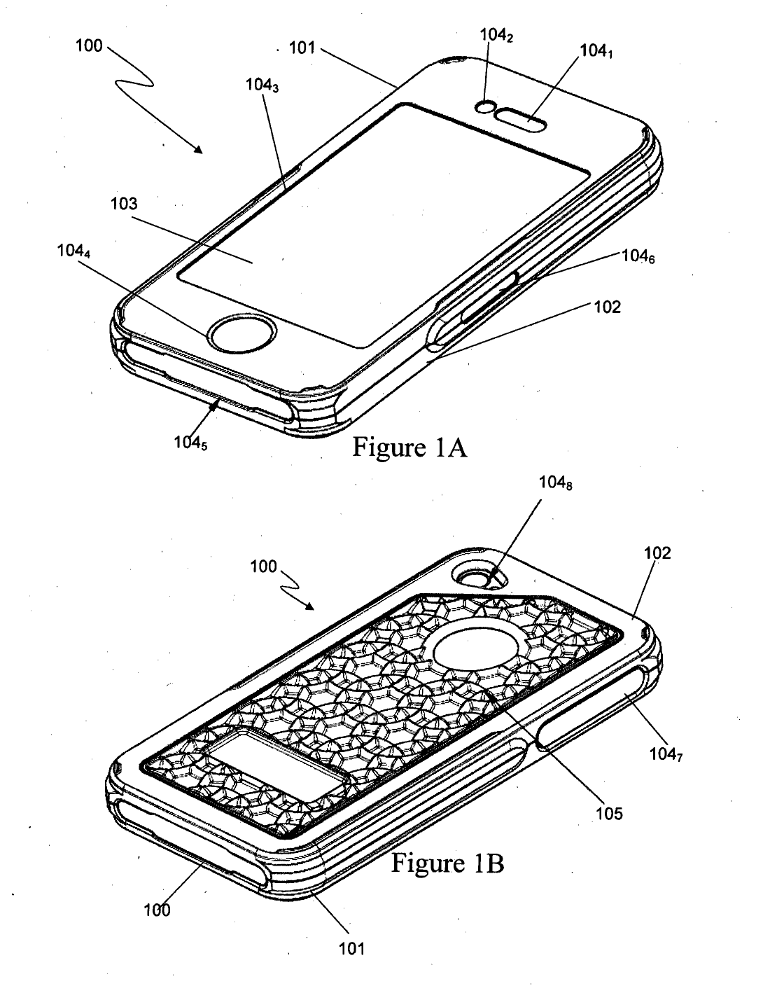

With reference to FIGS. 1A and 1B there is illustrated a one possible configuration of a protective case for a portable electronic device 100 according to one embodiment of the present invention. In this particular example the case is configured to fit a smart phone such as an iphone® or the like. It will of course be appreciated by those of skill in the art that the case 100 could be designed to fit any portable electronic device such as smartphone, tablet, gaming device etc. As shown the case includes a front shell 101 which is engaged with rear shell 102 to encapsulate the device 103 therebetween. Suitably the shells 101, 102 are constructed from a suitably durable material such as any suitable polymer, metals, fibre composites or the like

As can be seen in FIG. 1A the front shell 101 includes a number of cut outs 104₁, 104₂, 104₃, 104₄, 104₅, 104₆, 104₇ (see FIG. 1B) to accommodate various function buttons and auxiliary components of the device. Similarly the rear shell 102 includes cut outs 104₅, 104₆, 104₇ and 104₈. As will be appreciated by those of skill in the art the front and rear shells include scalloped sections which when the shells are brought into complementary engagement form the cut outs 104₅, 104₅, 104₇. Cut out 108 in the rear shell in this example is provided to accept an insert 105. The insert 105 may be provided with various decorative finishes, patterns other such surface treatments along with one or more sections for the provision of badges or other such devices.

As noted above the case in this particular example is designed to encapsulate a mobile phone as such the various cut outs such as 104₄ which align with the phone's data, charge and other ports for the attachment of peripheral devices such as head phones and the like, may be provided with removable covers. The covers are engaged with the ports when not in use to provide a water resistant seal between the cover and the case 100.

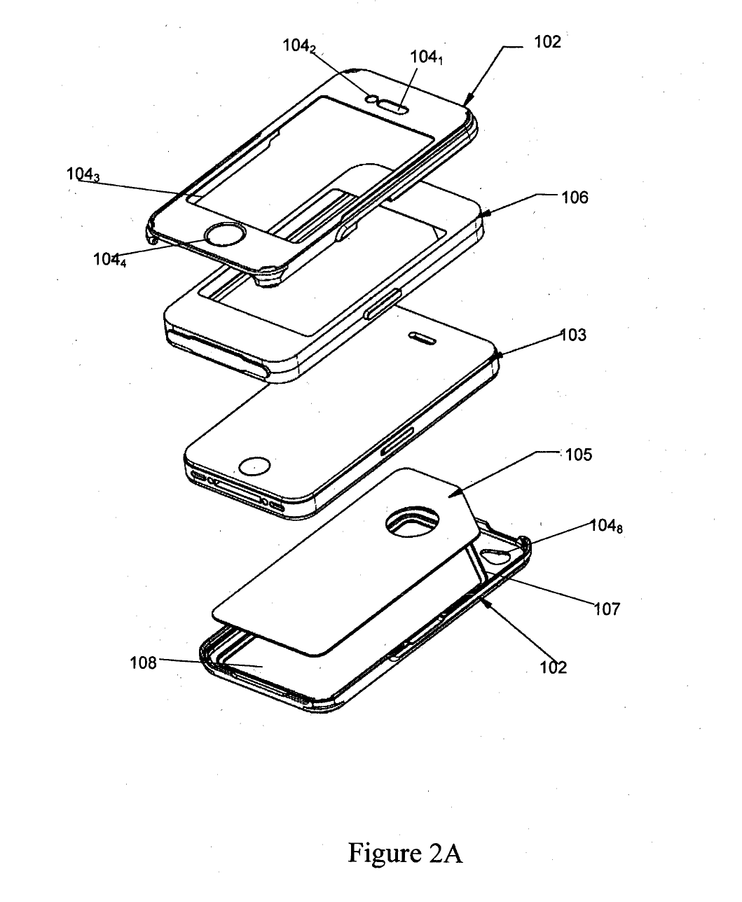

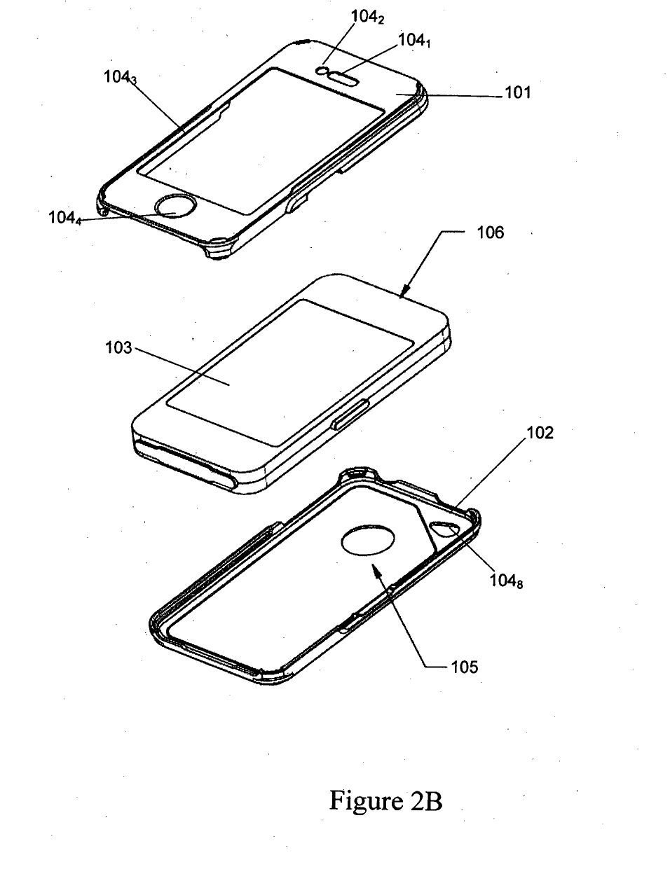

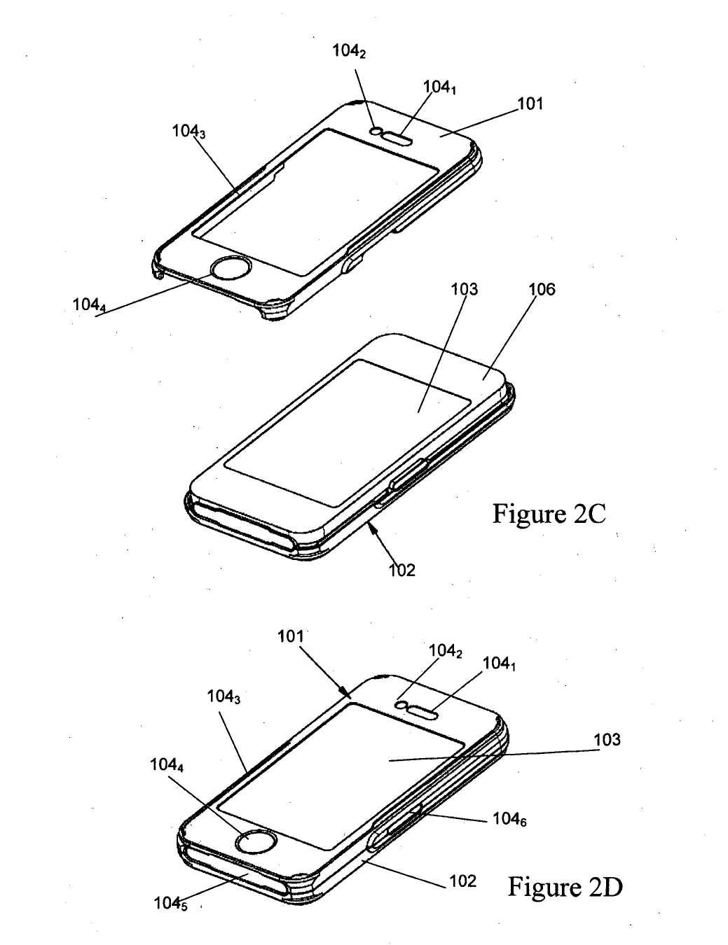

FIGS. 2A to 2D depict the case 100 during various stages of assembly. FIG. 2A depicts the case 100 completely disassembled. As can be seen, cut out 104₈ in rear shell 102 includes a recess 107 extending about its periphery for receipt of insert 105 such that when the assembly of the case is complete the insert finishes substantially flush with the rear face of the case 100. Recessing cut out 104₈ in this manner also assists with the creation of the moisture resistant seal between the case 100 and portable electronic device 103. As can be seen in this instance the case includes a sleeve 106 for receipt of the portable device 103. The sleeve 106 is may be formed from any suitable clear flexible water resistant material i.e. any suitable polymer such as a polyvinyl or polyurethane based polymer. Alternately the sleeve 106 could be formed from a translucent or opaque material such as silicone or the like in such cases the sleeve 106 would include a cut out to accommodate the screen which would have a suitable protective film (i.e. thin urethane based film which most commercially available protectors are construed from) applied before insertion into the sleeve 106. In some instances where the screen protective material and the remainder of the sleeve 106 are compatible the protector could be welded or adhered to the sleeve 106 prior to insertion of the device.

FIG. 2B depicts the initial stage of assembly of the cover 100 as can be seen in this instance the device 103 has been inserted into sleeve 106 and insert 105 has been positioned within recess 107. As can be seen the rear face of the insert 105 once positioned in the recess 107 finishes substantially flush with the interior surface of the rear shell 102. To complete the assembly of the case the device 103 encapsulated in the sleeve 106 is positioned within the shell 102 of the case 100 as shown in FIG. 2C and the front shell 101 is then engaged with the rear shell 102 thereby retaining the device 103 an sleeve 106 therein and completing the case 100.

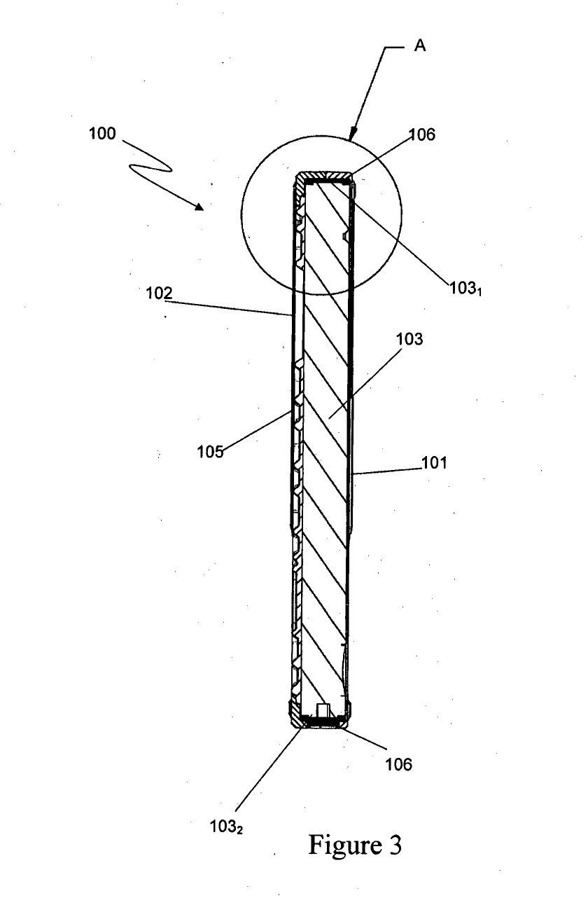

As briefly noted above the insert may serve to assist with the creation of moisture resistant seal between the device and the casing 100. As can be seen in the example depicted in FIGS. 2A to 2D the rear of the sleeve 106 is relatively open with a portion of the sleeve 106 extending over the upper 103₁ and lower 103₂ edges of the device 103 onto the rear face of the device 103. In these circumstances the insert 105 is constructed from a suitable flexible water resistant material such that when the rear of the device is positioned within the rear shell 102 the insert 105 acts to complete encapsulation of the device 103 within a water resistant cocoon. An example of the interaction of the insert 105, sleeve 106 and the rear 102 and front 101 shells of the case 100 can be seen in FIG. 3. As can be seen the complementary engagement of the front shell 101 and rear shell 102 sandwich the sleeve 106 and insert 105 against the device 103 to create a water resistant seal therebetween.

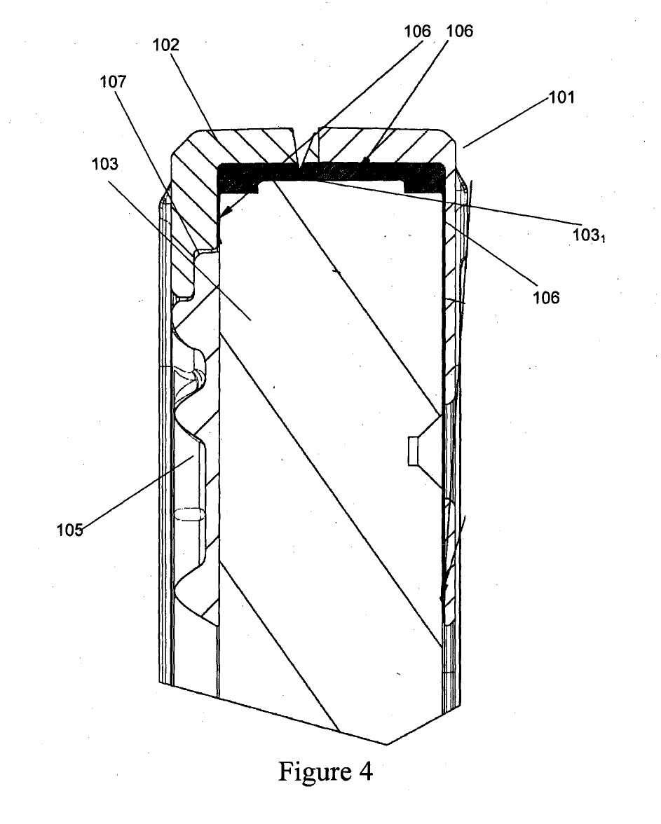

FIG. 4 depicts section A of FIG. 3 in further detail and more clearly illustrates the engagement about of the front 101 and rear 102 shells with the sleeve 106 and the insert 105. As shown engagement of the front shell 101 with rear shell 102 acts to sandwich the sleeve 106 and insert 105 against the device 103. More specifically engagement of the front shell 101 with the rear shell 102 forces the interior face of the front shell 101 into engagement with the sleeve 106 pressing the sleeve 106 against the front face of the device 103. Simultaneously the rear shell 102 is forced against the portion of the sleeve 106 which surrounds the upper edge 103₁ of the device 103. The pressure exerted between the two shells 101, 102 also places the rear face of the device into abutting relation with the insert 105 completing the encapsulation of the device 103 in water resistant envelope.

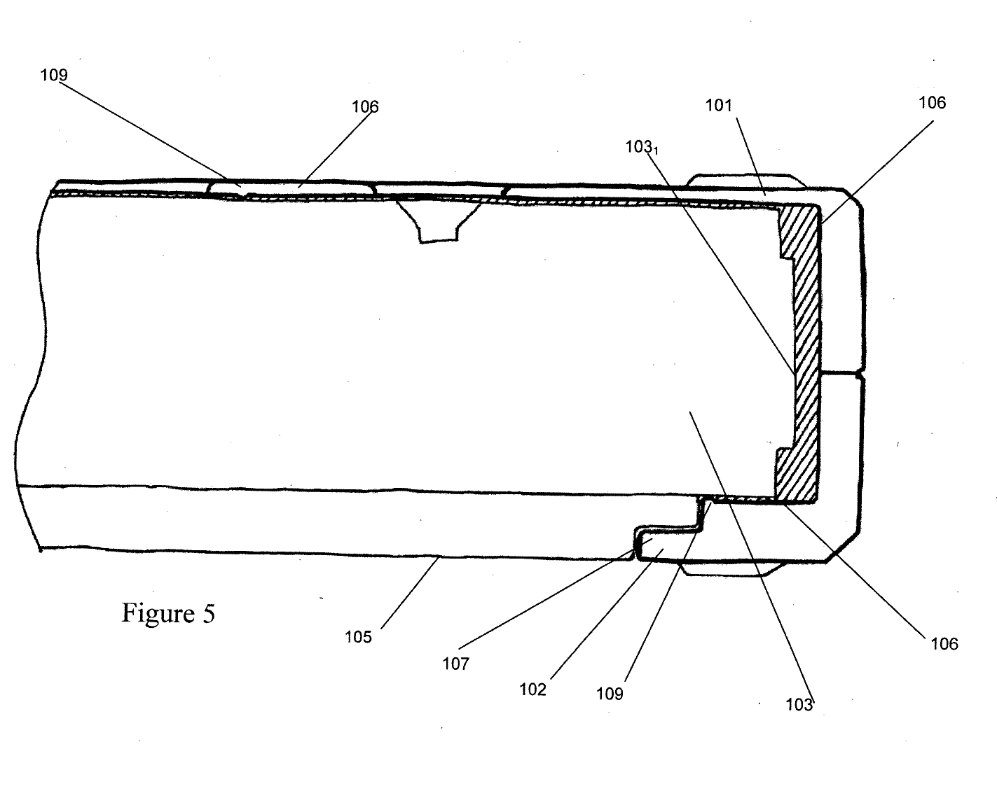

In the case of the above discussed example the water resistant seal is created via the pressure exerted on the sleeve 106, insert 105 by the shells 101, 102 to press them firmly against the device. While this arrangement provide for an adequate seal to prevent low level ingress events i.e. provides adequate protection against particulates and exposure to light moister e.g. perspiration etc. It will of course be appreciated by those of skill in the art that the seal can be enhanced by increasing the pressure exerted between the case and the sleeve 106. One example of how the pressure between the case and the sleeve can be increased to further enhance the moisture resistance of the seal is shown in FIG. 5.

As in the case of the above example the front 101 and rear 102 shells are brought into engagement about the device 103 and the sleeve 106. As noted above engagement of the front shell 101 with rear shell 102 again acts to sandwich the sleeve 106 and insert 105 against the device 103. More specifically engagement of the front shell 101 with the rear shell 102 forces the interior face of the front shell 101 into engagement with the sleeve 106 pressing the sleeve 106 against the front face of the device 103. Simultaneously the rear shell 102 is forced against the portion of the sleeve 106 which surrounds the upper edge 103₁ of the device 103. In the present example the engagement between the shells 101, 102 and the sleeve 106 is increase via the use of a series of projections 109 disposed at discrete points on the interior surfaces of the front 101 and rear 102 shells. As the front 101 and rear shells 102 are brought into engagement the projections are forced against the sleeve 106 this effectively pinches the sleeve 106 between the projections 109 and the device 103 creating a seal therebetween.

While in the above examples the case 100 provides a water resistant seal via the use of a sleeve 106 to encapsulate or partially encapsulate the device prior to insertion into the case, it will of course be appreciated by those of skill in the art that the water resistant seal could be achieved without the use of a sleeve 106 as discussed. For example the front and rear shells could each have layer of membrane disposed on their interior faces to enable access to the devices controls when the case 100 is assembled. In such instances sealing relation between the front and rear shells could be brought about more conventional arrangements such as the use of a sealing O-ring or grommet. In such cases the O-ring or grommet could be positioned within a channel disposed bailout the periphery of one of the shells with the opposing shell being provided with a flange for complementary with the channel such that when the shells are engaged the flange is forces against the O-ring or grommet to create a water tight seal. As in the above example the various ports etch which enable the device to be coupled to ancillary devices etc. could then be sealed utilising suitable inserts.

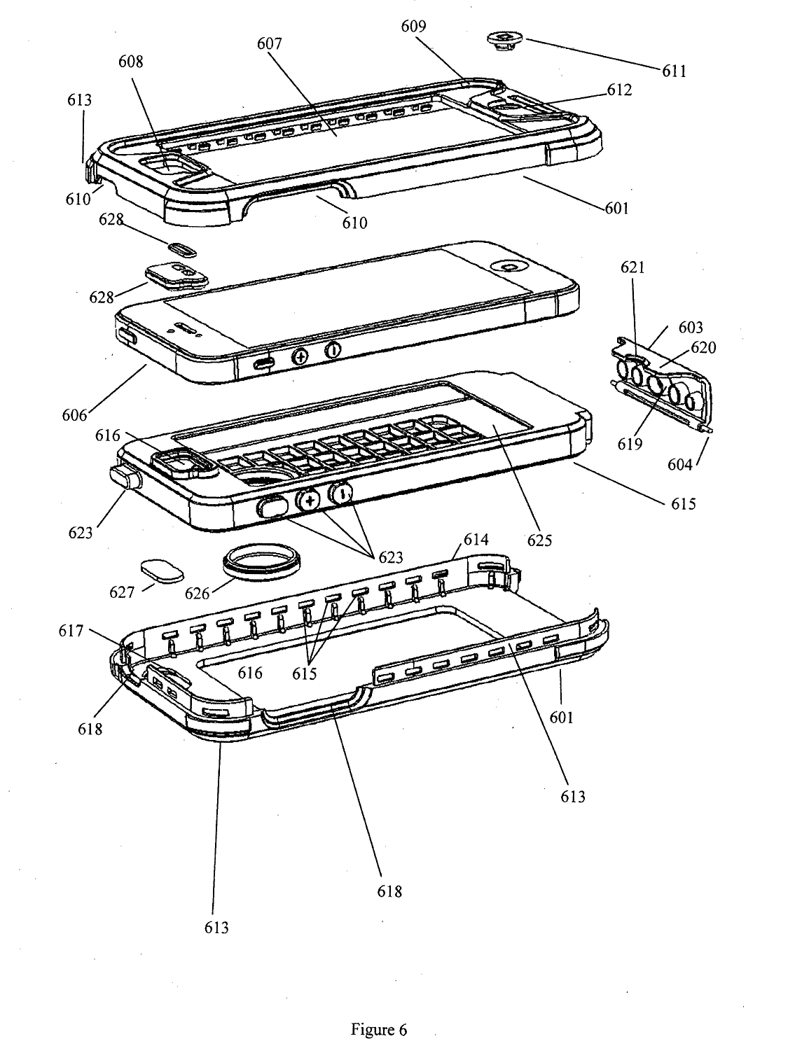

An alternative embodiment is illustrated in FIG. 6. This embodiment also includes a front shell 601 and a rear shell 602. The rear shell has a door 603 associated therewith mounted on a hinge pin 604 for rotation about the hinge pin relative to the rear shell 602. A sleeve 605 is also provided to be sandwiched and at least partially compressed between the front shell 601 and a rear shell 602 during assembly and in use.

The front shell 601 of the embodiment illustrated in FIG. 6 is approximately half the height of the device 606 illustrated in FIG. 6. A central opening 607 is provided to surround the screen of the device 606 such that the screen is unobstructed in this embodiment. There is also a secondary opening 608 in the front surface of the front shell to be located relative to a camera and speaker of the device 606.

There are also openings 610 illustrated in the side walls of the front shell 601 which correspond to openings in the rear shell 602. This will allow for other components of the device 606 to be accessible when the case is properly assembled surrounding device 606. The openings 610 are typically openings surrounded by a depression or located within a depression.

A button 611 is provided in the front shell 601. The button 611 is movable or depressible in order to actuate the button on the front surface of the device 606. The button 611 is provided with a rear portion that overlies and depresses the button on the device 606. The button is located above a portion of the sleeve 605 which surrounds the device 606 (that is a portion of the sleeve 605 is located between the rear portion of button 611 and the button of the device 606) and depression of the button 611 therefore depresses the sleeve which depresses the button of the device 606.

A depression is provided on the front surface 609 of the front shell 601 illustrated in FIG. 6. The depression 612 is located below the button 611 on the front shell 601 and is provided in order to receive a tongue provided on the door 603. Although not shown in FIG. 6, an opening is provided in the sidewall located at the bottom of the front shell 601 to allow the door 603 to close into the sidewall of the front shell 601, in effect so that the door 603 forms the sidewall or at least a portion thereof. A corner protector 613 is provided at each corner of the front shell 601 and it is preferred that the corner protectors are at least slightly resilient to provide cushioning for the device 606.

Although not clearly visible in the embodiment illustrated in FIG. 6, an inner surface of at least one of the sidewalls of the front shell 601 is provided with a plurality of abutment configurations, each including an abutment shoulder located adjacent a sloped portion. The abutment configurations will typically be triangular shaped and the provision of the sloped portion will result in the abutment configurations converging towards the front face of the front shell 601. The abutment shoulder of each abutment configuration is therefore closer to the front surface 609 of the front shell 601 than to the open rear of the front shell.

Located adjacent to the abutment configurations are a series of guide legs which are provided between the abutment configurations in an alternating pattern. The guide legs are spaced from the internal surface of the sidewall relative to which they are located to define a receiving gap therebetween. A series of abutment configurations and guide legs are located on and adjacent at least the lateral side walls and a top sidewall (remembering that in this preferred configuration the majority of the bottom sidewall is absent to allow for the door 603.

The internal corners of the front shell are also provided with abutment configurations similar to those provided on the side walls but arcuate rather than being straight, in order to be located in the arcuate corners of the front shell 601. There is preferably one abutment configuration located in each corner of the front shell 601.

The rear shell 602 illustrated in FIG. 6 is similar to the front shell 601 in that the rear shell 602 also includes sidewalls which are approximately half the height of the device 606. However, in the rear shell 602, the sidewalls are provided with an inner extension portion 614 which extends further toward the front shell 601 than the sidewall does, normally integrally formed with the sidewall. The inner extension 614 functions as both a location extension and also assists with attachment of the front shell 601 to the rear shell 602. The inner extension is preferably provided with a series of openings 615 spaced from a free edge thereof, the location of the series of openings corresponding to the locations of the abutment configurations on the front shell 601. The receiving gap provided on the front shell 601 between the guide legs and the sidewall preferably receives the inner extension between the guide leg and an inner surface of the sidewall of the front shell 601, between the openings 615.

There are also typically openings are provided in the corners of the rear shell 602 to correspond to the abutment configurations provided in the corners of the front shell 601. A central opening is provided in the rear surface of the rear shell 602 in order to allow the insert portion of the sleeve 605 to extend into or through. An upper opening is provided in a rear surface of the rear shell 602 to allow for location of a camera of the device 606. Sidewall openings 618 are provided in the sidewalls of the rear shell 602 corresponding in position to the openings 610 provided on front shell 601.

As mentioned previously, the door 603 is provided at a lower end of the rear shell 602 attached by the hinge pin 604. The door of the embodiment illustrated in FIG. 6 is substantially. L-shaped. The L-shaped door 603 includes a first portion 619 to cover the lower end edge of the device 606 and a second portion 622 extends partially over the front surface 609 of the front shell 601 to maintain the door 603 in the closed condition. A tongue is preferably provided on the second portion 620 in order to be located within the depression 612 to close the door 603. A raised portion 621 is provided on an outer surface of the second portion of the door 603 in order to allow manual unlatching of the door.

The second portion 620 of the door is shaped to be received in a shaped depression on the face of the front shell 601.

The first portion 619 of the door 603 is provided with one or more openings therethrough in order to correspond with the location of the speaker or microphone on the device 606. The first portion 619 of the door 603 as illustrated in FIG. 6 also includes a number of tubular extensions 622 in order to be at least partially received in a portion of the sleeve 605 overlying the power charger cable port and headphone port of the device 606 illustrated in FIG. 6 but clearly the location and type of these extensions will be device-specific and different cases provided for different devices will have different configurations of extension 622. The extensions 622 illustrated in FIG. 6 may surround openings through the first portion 619 of the door 603 and typically, are at least partially received in openings in the sleeve corresponding to at least the ports in the device 606. The rear shell 602 also includes corner protectors 613 which are preferably resilient.

The sleeve 605 illustrated in FIG. 6 is a resilient sleeve with one or more rigid portions or inserts provided therein to overlie specific portions of the device 606 when located in the sleeve 605. A number of shaped buttons 623 are provided on the sidewalls of this sleeve 605 corresponding in shape and position to the shape and position of the buttons provided on the device 606. The buttons 623 on the sleeve 605 may also be provided with identification indicia to identify the function of the buttons of the device 606. Each of the buttons 623 provided is also solid in order to convey force to the buttons of the device 606 when buttons 623 are manipulated.

As illustrated in FIG. 6, the sleeve 605 extends across the rear of the device 606, over the side edges of the device and up over at least a portion of the front surface of the device 606. The sleeve 605 may extend further over the device at the upper and lower portions than at the sides.

The portions of the front face of the sleeve illustrated in FIG. 6 are coplanar with one another such that the force applied by the front shell 601 is evenly spread across the face of the device 606 to create a seal. Another way to look at the configuration of the sleeve 605 is that the sleeve 605 is a closed sleeve designed to encapsulate the device 606 buty with a substantially rectangular cutout 624 in the front wall of the sleeve. An enlarged portion 625 is provided on the rear wall of the sleeve 605 (which is better illustrated in FIG. 7) in order to act as an insert through the central opening 616 in the rear shell 602. The size, shape and location of the enlarged portion 625 corresponds with the size, shape and location of the central opening 616 in the rear shell 602.

A window insert 626 is provided in the enlarged portion 625 of the sleeve 605 illustrated in FIG. 6. In this embodiment, the window insert 626 is transparent to allow brand placement for the device 606.

An insert 627 is provided in a rear surface of the sleeve 605 to allow for the lens of the camera in the rear of the device 606. This insert 627 will typically be provided with an enlarged periphery on the rear side thereof in order to be received within the opening 617 in the rear of the rear shell 602.

An insert 628 is provided in a front surface of the sleeve 605 to allow for a lens of the camera in the front of the device 606. This insert 628 will typically be provided with an enlarged periphery on the front side thereof in order to be received within the opening 608 in the front of the front shell 601.

A further insert 629 is provided in a bottom edge surface of the sleeve 605 to allow for the microphone, speaker, power charger port and headphone port in the bottom edge of the device 606. This insert 629 will typically be provided with an enlarged periphery on an outer side thereof in order to be engage with the configurations provided on the first portion 619 of the door 603.

The embodiment of the case illustrated in FIG. 7 is similar in many respects to that illustrated in FIG. 6 but with some additional components such as the microphone membrane 630 located in the lower insert 629 and retained there by the microphone frame 631.

As with previous embodiments, the device 606 is received within the sleeve 605 by deforming the sleeve 605 to encompass the device 606. The sleeve 605 is then compressed during assembly and closing of the front and rear shells due to the fact that it is slightly larger externally then the internal dimension of the front shell 601 and rear shell 602 when assembled. The assembled case compresses the shell between portions of the case to seal the device therein but leave the screen or display of the device 606 unobstructed and provide access (indirectly) to the operating components of the device.

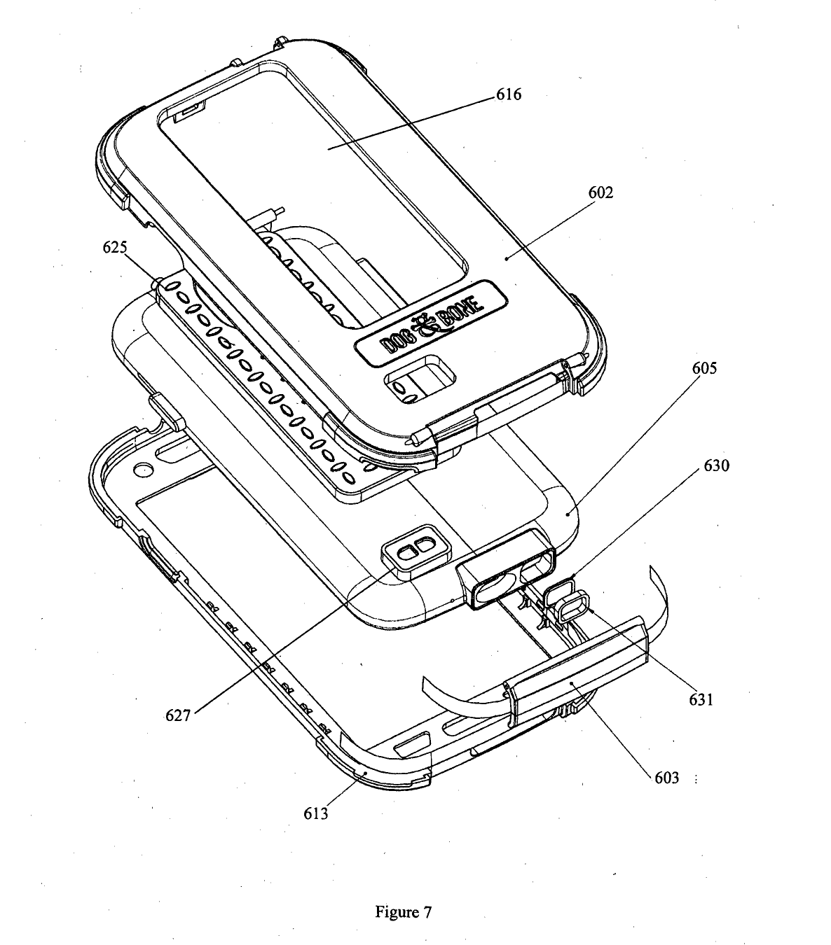

One preferred embodiment of door assembly and secondary sealing arrangement is illustrated in FIGS. 8A to 8D.

In FIG. 8A, a lower portion of an assembled case is illustrated with the door 603 illustrated in the open condition. Also illustrated is the lower insert 629 in which there is a charging port opening 800 and a microphone cover 801. The insert has a perimeter seal 802 standing proud of the insert 629 extending about the perimeter of the lower insert 629. In addition, the door 603 is provided with a silicon rubber pad 803 which is illustrated in more detail in FIG. 8D. In this embodiment, the silicon rubber pad 803 pushes through an opening in the door 603 in order to be retained there. The silicon rubber pad 803 is larger than the charging port opening 800 but small enough that it fits within the space defined by the perimeter seal 802. When the door 603 is closed, the perimeter seal 802 abuts the surface of the door 603, and the silicon pad 803 abuts the charging port opening 800 within the perimeter seal 802 to provide at least two seals which water or dust would have to pass in order to obtain entry to the charging port of the device 606.

The lower insert 629 in this form is illustrated in further detail in FIGS. 8B and 8C and the raised periphery of the charging port opening 800 is particularly illustrated in FIG. 8C.

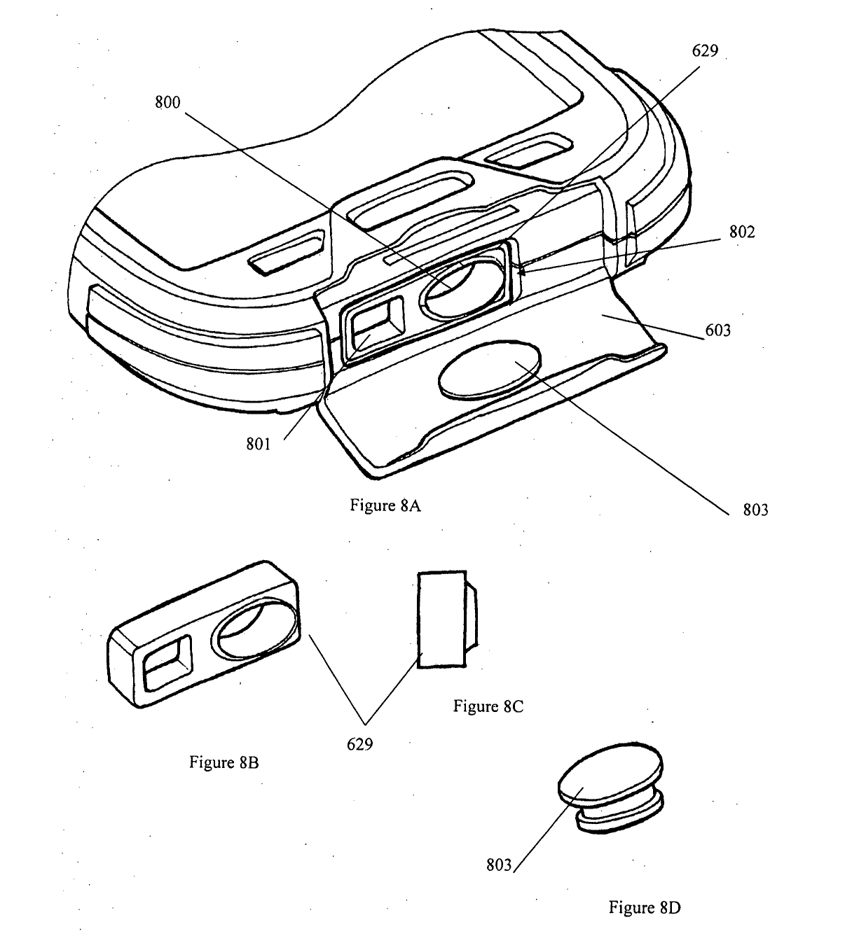

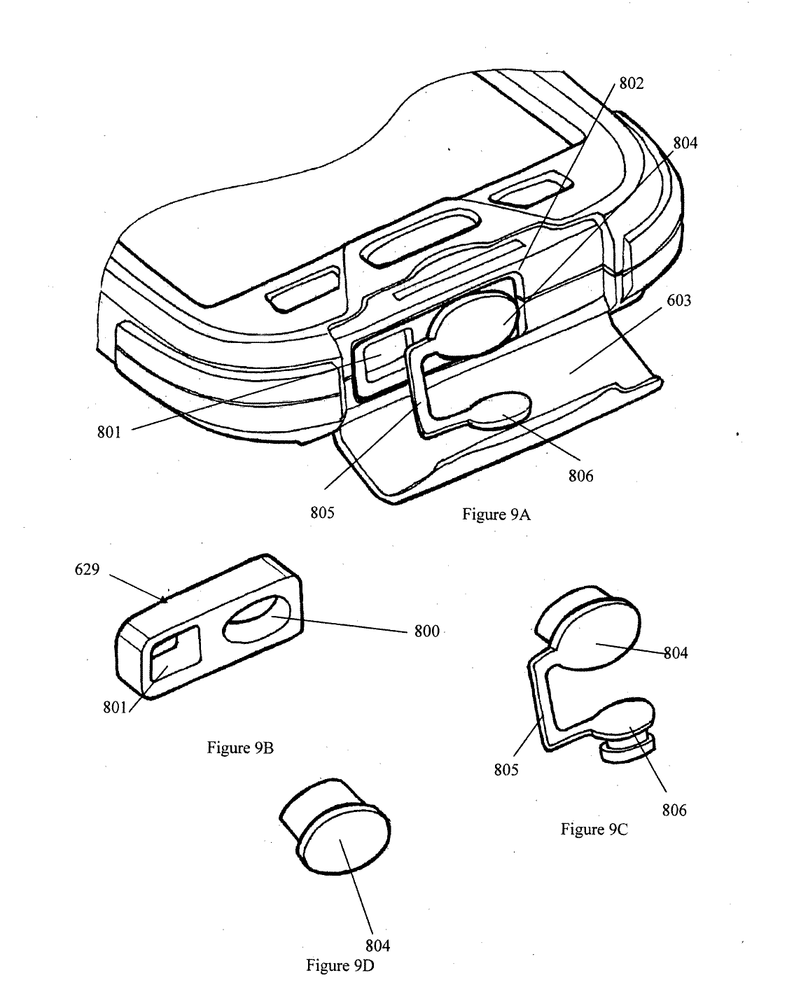

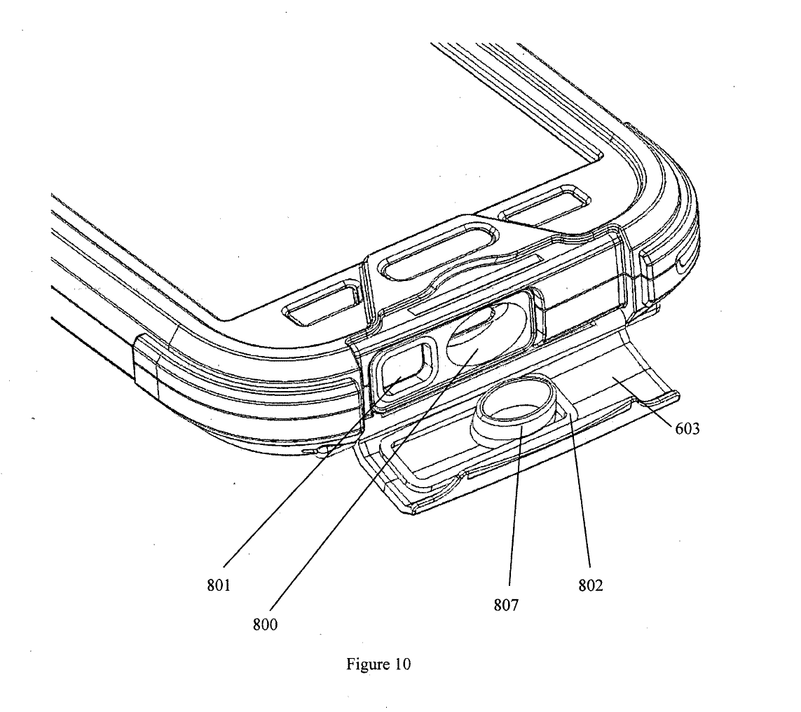

Another preferred embodiment of door assembly and secondary sealing arrangement is illustrated in FIGS. 9A to 9D.

In FIG. 8A, a lower portion of an assembled case is illustrated with the door 603 illustrated in the open condition. Also illustrated is the lower insert 629 in which there is a charging port opening 800 and a microphone cover 801. The insert has a perimeter seal 802 standing proud of the insert 629 extending about the perimeter of the lower insert 629. In addition to this, and in contrast with the embodiment illustrated in FIG. 8A, a silicon rubber plug 804 is provided at the end of a tether 805 with a fixing bung 806 provided at the other end of the tether 805. The fixing bung operates in a manner similar to the silicon pad 803 illustrated in FIG. 8A, extending through an opening in the door in order to secure the tether 805 and the silicon plug 804 relative to the door 603. In use, the silicon plug 804 is inserted into the charging port opening 800 prior to closing the door 603. Again, a preferred form of the lower insert 629 is illustrated in FIG. 9B, this form not provided with the raised periphery.

An alternative silicon plug 804 without the tether may be provided and one form of this is illustrated in FIG. 9D. In this embodiment, the silicon plug will normally be located relative to the door 603 such that closing the door inserts the rubber plug into the charging port opening 800.

In the embodiment illustrated in FIG. 10, the door 603 is provided with a perimeter seal 802 and a tubular silicon extension 807. Again, when the door 603 is closed, the silicon extension 807 is received at least partially in the charging port opening 800 and the perimeter seal abuts the lower insert 629 in order to provide two levels of sealing.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

1. A housing for a portable electronic device including a first housing member adapted for complementary engagement with a second housing member, a sleeve for encapsulation of the portable electronic device, and whereby a moisture resistant seal is provided on engagement of the first and second housing members about the sleeve and said portable electronic device.

2. The housing of claim 1, wherein the housing includes one or more cut out sections to accommodate, various function buttons and auxiliary components of the portable electronic device.

3. The housing of claim 2, wherein the first and second housing members include one or more scalloped sections which on engagement of the housing members form one or more of the cut out sections.

4. The housing of claim 1, wherein the sleeve fully encapsulates the portable electronic device.

5. The housing of claim 1, wherein the sleeve is clear flexible water resistant material.

6. The housing of claim 1, wherein the portable electronic device utilises a capacitive or resistive screen and the portion of the sleeve covering the screen is of sufficient transmissibility to permit registration of a screen tap or other such gesture.

7. The housing of claim 1, wherein the sleeve partially encapsulates the portable electronic device.

8. The housing of claim 7, wherein the at least one of the housing members includes a portion adapted to receive an insert and wherein the insert co-operates with the sleeve to form the moisture resistant seal.

9. The housing of claim 7, wherein the insert is constructed from a moisture resistant material.

10. The housing of claim 1, wherein the insert finishes substantially flush with the interior and exterior faces of the housing member in which it is installed.

11. The housing of claim 10, wherein the portion of the insert which finishes substantially flush with the exterior face of the housing member includes one or more surface effects.

12. The housing of claim 1, further including one or more plugs for capping one or more ports of the portable electronic device.
